(19) United States
(12) Patent Application Publication
(10) Pub. No.: US 2024/0205895 A1
(43) Pub. Date: Jun. 20, 2024

(54) METHODS, DEVICES, AND SYSTEMS FOR TRANSMITTING MULTIPLE TRANSPORT BLOCKS

(71) Applicant: ZTE Corporation, Shenzhen (CN)

(72) Inventors: Yan XUE, Shenzhen (CN); Feng Xie, Shenzhen (CN); Hanchao Liu, Shenzhen (CN); Fei Wang, Shenzhen (CN); Jun Xu, Shenzhen (CN)

(73) Assignee: ZTE Corporation, Shenzhen (CN)

(21) Appl. No.: 18/591,164

(22) Filed: Feb. 29, 2024

Related U.S. Application Data
(63) Continuation of application No. PCT/CN2021/123033, filed on Oct. 11, 2021.

(51) Int. Cl. H04W 72/0446; H04L 1/00; H04L 1/1812; H04W 72/0453; H04W 72/231

(52) U.S. Cl. CPC H04W 72/0446; H04L 1/0003; H04L 1/1812; H04W 72/0453; H04W 72/231

(57) ABSTRACT

The present disclosure describes methods, system, and devices for transmitting multiple transport blocks (TBs). The method includes transmitting a set of TBs between a first wireless device and a second wireless device by receiving, by the second wireless device, a resource indication from the first wireless device, wherein: the resource indication indicates resource allocation of the set of TBs in a resource space comprising a time unit in a time domain and a frequency unit in a frequency domain; each TB mapped to a same codeword in the set of TBs is mapped to different time-frequency resource in the resource space; the set of TBs comprises n TBs mapped to the same codeword, and n is an integer larger than 1; and each TB in the set of TBs is capable of being packaged separately at a transmitting end, and capable of being delivered separately to an upper layer at a receiving end.

### TECHNICAL FIELD

The present disclosure is directed generally to wireless communications. Particularly, the present disclosure relates to methods, devices, and systems for transmitting multiple transport blocks (TBs).

### BACKGROUND

Wireless communication technologies are moving the world toward an increasingly connected and networked society. High-speed and low-latency wireless communications rely on efficient network resource management and allocation among one or more user equipment and one or more wireless access network nodes (including but not limited to base stations). A new generation network is expected to provide high speed, low latency and ultra-reliable communication capabilities and fulfill the requirements from different industries and users.

With the rapid evolution of cellular mobile communication systems, more and more applications emerge in various businesses and/or service industries. Some services, such as holographic communication, industrial internet traffic and immersive cloud extended reality (XR), need to meet both ultra-high throughput and ultra-low latency at the same time. This type of services not only has extremely high requirements for throughput, but also high requirements for low latency. There are problems or issues associated with the present wireless communication technology, and it is difficult to meet the reliable transmission of data at a large volume under low-latency requirements.

The present disclosure describes various embodiments for transmitting multiple transport blocks (TBs), addressing at least one of the problems/issues discussed above. The various embodiments in the present disclosure may enhance performance of enhanced mobile broadband (eMBB) and/or ultra reliable low latency communication (URLLC) and/or provide new scenarios requiring large bandwidth and low latency, improving a technology field in the wireless communication.

### SUMMARY

This document relates to methods, systems, and devices for wireless communication, and more specifically, for transmitting multiple transport blocks (TBs).

In one embodiment, the present disclosure describes a method for wireless communication. The method includes transmitting a set of transport blocks (TBs) between a first wireless device and a second wireless device by receiving, by the second wireless device, a resource indication from the first wireless device, wherein: the resource indication indicates resource allocation of the set of TBs in a resource space comprising a time unit in a time domain and a frequency unit in a frequency domain; each TB mapped to a same codeword in the set of TBs is mapped to different time-frequency resource in the resource space; the set of TBs comprises n TBs mapped to the same codeword, and n is an integer larger than 1; and each TB in the set of TBs is capable of being packaged separately at a transmitting end, and capable of being delivered separately to an upper layer at a receiving end.

In another embodiment, the present disclosure describes a method for wireless communication. The method includes receiving, by a second wireless device, a higher layer message carrying a radio configuration information of a set of TBs, wherein: the set of TBs comprises n TBs mapped to a same codeword, and n is an integer larger than 1, each TB mapped to the same codeword in the set of TBs is mapped to different time-frequency resource in a resource space comprising a time unit in a time domain and a frequency unit in a frequency domain, and each TB in the set of TBs is capable of being packaged separately at a transmitting end, and capable of being delivered separately to an upper layer at a receiving end; and in response to the higher layer message, operating, by the second wireless device, according to the radio configuration information of the set of TBs.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include a core network, a first wireless device, a second wireless device, a third wireless device, and a fourth wireless device.

FIG. 2 shows an example of a wireless network node.

FIG. 3 shows an example of a user equipment.

FIG. 4A shows a schematic diagram of an embodiment in the present disclosure for wireless communication.

FIG. 4B shows a schematic diagram of an embodiment in the present disclosure for wireless communication.

FIG. 5 shows a schematic diagram of an embodiment in the present disclosure for wireless communication.

FIG. 6 shows a flow diagram of a method for wireless communication.

FIG. 7 shows a flow diagram of a method for wireless communication.

FIG. 8 shows a schematic diagram of an embodiment in the present disclosure for wireless communication.

FIG. 9 shows a schematic diagram of an embodiment in the present disclosure for wireless communication.

FIG. 10A shows a schematic diagram of an embodiment in the present disclosure for wireless communication.

FIG. 10B shows a schematic diagram of an embodiment in the present disclosure for wireless communication.

FIG. 11A shows a schematic diagram of an embodiment in the present disclosure for wireless communication.

FIG. 11B shows a schematic diagram of an embodiment in the present disclosure for wireless communication.

FIG. 11C shows a schematic diagram of an embodiment in the present disclosure for wireless communication.

FIG. 12A shows a schematic diagram of an embodiment in the present disclosure for wireless communication.

FIG. 12B shows a schematic diagram of an embodiment in the present disclosure for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for transmitting multiple transport blocks (TBs).

New generation (NG) mobile communication system are moving the world toward an increasingly connected and networked society. High-speed and low-latency wireless communications rely on efficient network resource management and allocation among one or more user equipment and one or more wireless access network nodes (including but not limited to wireless base stations). A new generation network is expected to provide high speed, low latency and ultra-reliable communication capabilities and fulfill the requirements from different industries and users.

With the rapid evolution of cellular mobile communication systems, more and more applications emerge in various businesses and/or service industries. Some services, such as holographic communication, industrial internet traffic and extended reality (XR), need to meet both ultra-high throughput and ultra-low latency. This type of services integrates the characteristics of the two scenarios of high performance and high efficiency wireless networks: extremely high requirements for throughput, but also high requirements for low latency. For example but not limited, the large bandwidth, high throughput, and low latency scenarios may need the reliable transmission of data at a large volume under low-latency requirements.

In a 4G and/or a 5G system, on a baseband carrier (e.g., also called a single cell), each transport block (TB) may be scheduled for transmission on a baseband carrier with a transmission time interval (TTI) as a basic time-domain scheduling unit. Each hybrid automatic repeat request (HARQ) process may be in a TTI. A TB is called a codeword after channel coding process. In the spatial multiplexing transmission, there are up to two codewords, which is called the first codeword and the second codeword according to the layer mapping configuration. A codeword may be mapped to all or part of the layers. Multiple different data streams can be transmitted on different layers simultaneously. After using the spatial multiplexing technology, a UE may be allowed to transmit one TB on a carrier and a HARQ process in response to a single codeword transmission; and/or a UE may be allowed to simultaneously transmit two TBs on a carrier and a HARQ process in response to two codewords transmission. In other words, for the same user, no more than two TBs may be scheduled in a time-domain transmission unit. In order to increase the throughput, one way is to increase the number of bits contained in a TB, that is, to expand the TB Size (TBS). However, considering factors such as coding and interleaving gain, the TB size is limited. For example, in long term evolution (LTE), a TBS may be required to be no greater than 6144 bits. In response to a TB being larger than 6144 bits, this TB may be divided into multiple code blocks (Code Block, CB) for encoding and transmission.

In various embodiments, each TB may include a cyclical redundancy check (CRC), and each CB in each TB may also include a CRC. When the CRC check of a certain CB fails, only this CB may need to be retransmitted, and the entire TB may not need to be retransmitted.

In some implementations in a 5G new radio (NR), in order to reduce the feedback overhead of CB transmission, a code block group (CBG) method may be used for feedback, that is, multiple CBs may be used as a group to use 1 bit for acknowledgement/negative acknowledgement (ACK/NACK) feedback. One of the issues associated with this approach may be that, when a CB is unsuccessful in transmission, the entire CBG where the wrong CB is located must be retransmitted. Only when the CRC check of all CBs and the CRC check of the entire TB pass, the TB transmission may be considered successful. After using code block segmentation, as the number of CBs and CBGs increases, the supported TBS may increase as well. Because each CB needs a CRC check, the larger the TB, the higher the possibility of CB transmission failure. CB transmission failure may result in CB retransmission. As long as there is a CB transmission failure in the TB, it may be retransmitted and waited. After all the CB transmissions are successful and the CRC of the CB level and the TB level are both verified, the TB may be delivered to the upper layer. One of the issues/problems with this approach is that the more CB and CBG, the longer the waiting time may be. For services with high latency requirements, such as live video services, data packets must be transmitted correctly within a certain period of time. When it times out, even the transmission is correct, it will be considered unsatisfactory and discarded. Thus, the existing technology may be difficult to meet the requirements of high throughput and low latency at the same time. The larger the TBS, the greater the transmission delay; and the smaller the TBS, the lower the throughput. One of the issues/problems associated with some of the above approaches may be that, for large bandwidth scenarios, even when frequency domain resources are sufficiently available, large throughput and low delay transmission may be difficult to achieve simultaneously.

The present disclosure describes various embodiments for transmitting multiple transport blocks (TBs), addressing at least one of the problems/issues discussed above. The present disclosure may enhance performance of enhanced mobile broadband (eMBB) and/or ultra reliable low latency communication (URLLC), improving a technology field in the wireless communication.

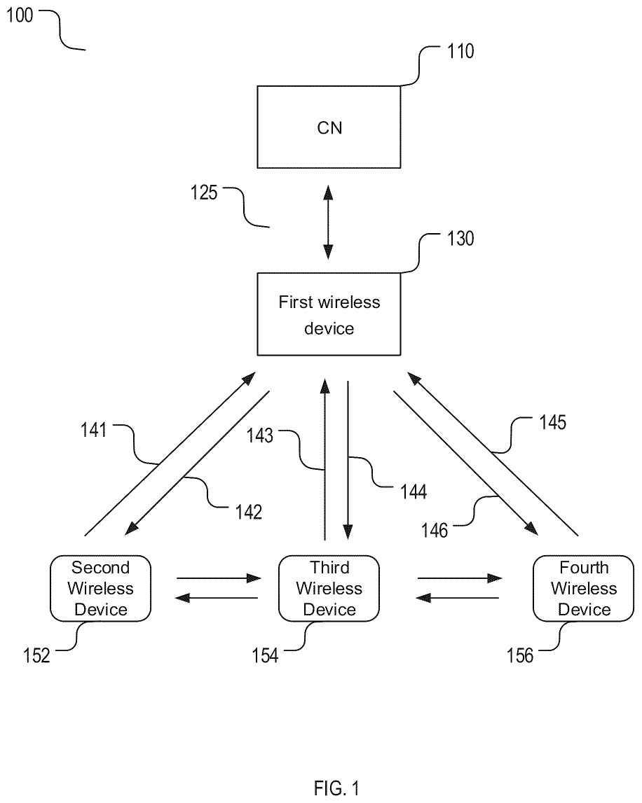

FIG. 1 shows a wireless communication system 100 including a portion or all of the following: a core network (CN) 110, a first wireless device 130, a second wireless device 152, a third wireless device 154, and a fourth wireless device 156. There may be wireless communication between any two of the first wireless device, the second wireless device, the third wireless device, and the third wireless device.

The first wireless device may include one of the following: a base station; a MAC layer in a wireless device; a scheduling unit; a user equipment (UE); an on-board unit (OBU); a road-side unit (RSU); or an integrated access and backhaul (IAB) node.

The second wireless device, the third wireless device, or the third wireless device may include one of the following: a user equipment (UE); or an integrated access and backhaul (IAB) node.

In various embodiments, the first wireless device 130 may include a wireless node. The second wireless device, the third wireless device, and/or the third wireless device may include one or more user equipment (UE) (152, 154, and 156). The wireless node 130 may include a wireless network base station, a radio access network (RAN) node, or a NG radio access network (NG-RAN) base station or node, which may include a nodeB (NB, e.g., a gNB) in a mobile telecommunications context. In one implementation, the core network 110 may include a 5G core network (5GC or 5GCN), and the interface 125 may include a NG interface. The wireless node 130 (e.g, RAN) may include an architecture of separating a central unit (CU) and one or more distributed units (DUs). In another implementation, the wireless network may include a 6G network or any future generation network.

The communication between the RAN and the one or more UE may include at least one radio bearer or channel radio bearer/channel). Referring to FIG. 1, a first UE 152 may wirelessly receive from the RAN 130 via a downlink radio bearer/channel 142 and wirelessly send communication to the RAN 130 via a uplink radio bearer/channel 141. Likewise, a second UE 154 may wirelessly receive communicate from the RAN 130 via a downlink radio bearer/channel 144 and wirelessly send communication to the RAN 130 via a uplink radio bearer/channel 143; and a third UE 156 may wirelessly receive communicate from the RAN 130 via a downlink radio bearer/channel 146 and wirelessly send communication to the RAN 130 via a uplink radio bearer/channel 145.

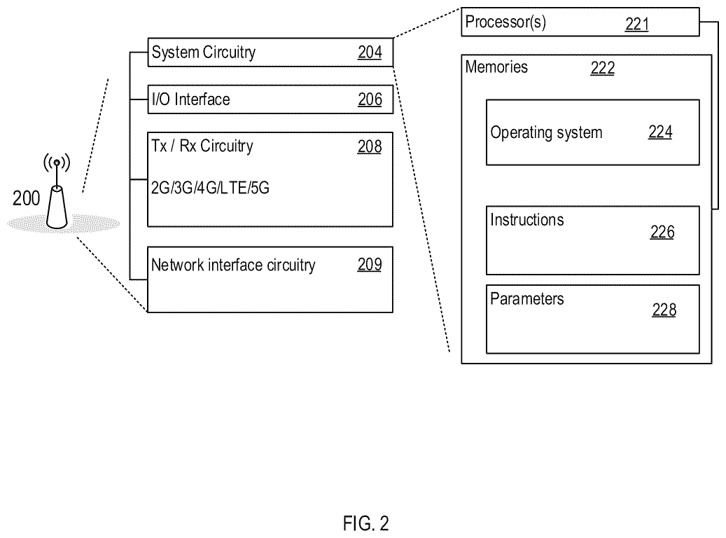

FIG. 2 shows an example of electronic device 200 to implement a network base station (e.g., a radio access network node), a core network (CN), and/or an IAB node. Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

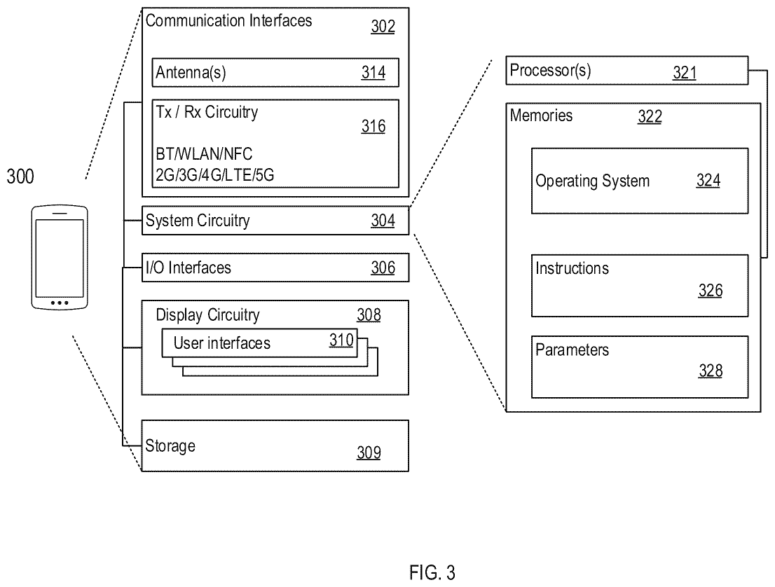

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G, 6G, or any future generation communication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes various embodiments for transmitting multiple transport blocks (TBs), which may be implemented, partly or totally, on one or more electronic device 200 and/or one or more terminal device 300 described above in FIGS. 2-3. Various embodiments includes transmission method for transmitting multiple TBs on a single HARQ process, solving at least one of the problems in achieving large bandwidth, large throughput and low latency transmission.

In various embodiments, unless specifically stated, the description may be described with a single (or one) codeword transmission on a single carrier as examples. But a two codeword transmission may be applicable as well for at least some of the various embodiments.

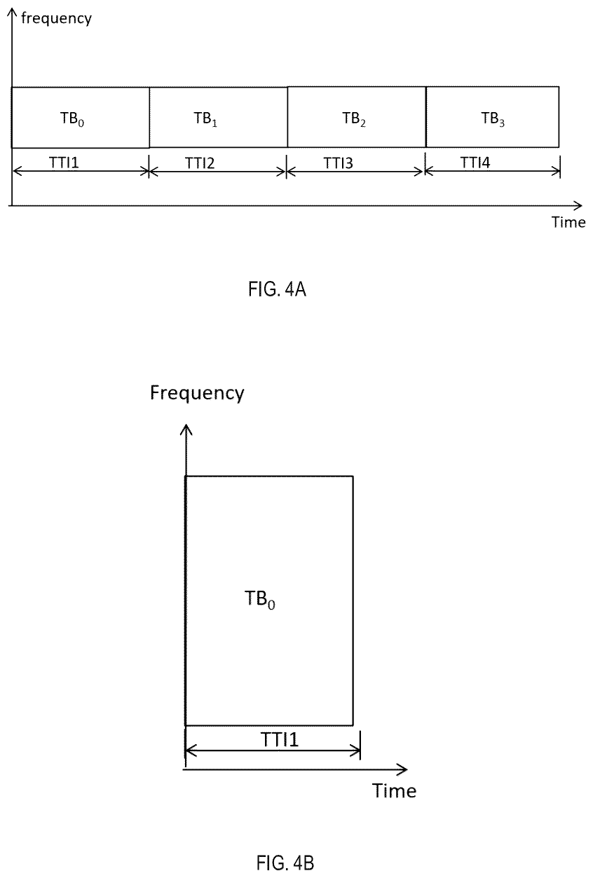

In some implementations of a 5G system, for a single codeword transmission on a single carrier, each HARQ process may only transmit one TB of the user on a TTI, as shown in FIG. 4A and FIG. 4B.

Referring to FIG. 4A, four TBs (TB₀, TB₁, TB₂, and TB₃) are mapped to four TTIs (TTI1, TTI2, TTI3, and TTI4), respectively in a time domain and a frequency domain. Referring to FIG. 4B, a TB (TB₀) is mapped to a TTI in a time domain and a frequency domain.

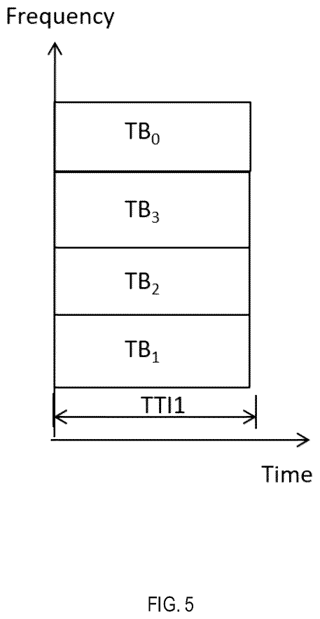

In other implementations, the present disclosure describes a transmission of multiple TBs in a single HARQ process on a TTI, as shown in FIG. 5. The multiple TBs may be mapped to a TTI in a time domain and a frequency domain. A mapping rule/policy/method of the multiple TBs in frequency or time domain may be describes in at least one or a combination of more than one embodiments described below. For example, in FIG. 5, four TBs (TB₀, TB₁, TB₂, and TB₃) are mapped in an order of TB₁, TB₂, TB₃, and TB₀ in the frequency domain.

In various embodiments in the present disclosure, a single carrier may be represented by a single cell in a wireless communication system, for example, in 4G and/or 5G communications.

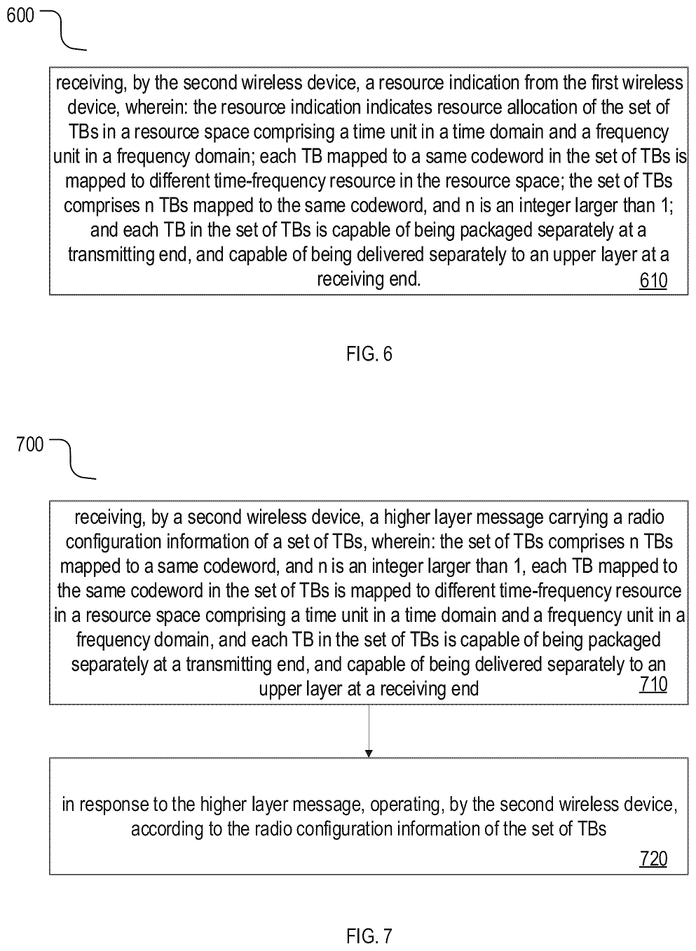

In various embodiment, referring to FIG. 6, a method 600 for wireless communication includes transmitting a set of transport blocks (TBs) between a first wireless device and a second wireless device. The method 600 may include step 610, receiving, by the second wireless device, a resource indication from the first wireless device, wherein: the resource indication indicates resource allocation of the set of TBs in a resource space comprising a time unit in a time domain and a frequency unit in a frequency domain; each TB mapped to a same codeword in the set of TBs is mapped to different time-frequency resource in the resource space; the set of TBs comprises n TBs mapped to the same codeword, and n is an integer larger than 1; and each TB in the set of TBs is capable of being packaged separately at a transmitting end, and capable of being delivered separately to an upper layer at a receiving end.

In some implementations, the resource space corresponds to the set of TBs in a hybrid automatic repeat request (HARQ) process in a carrier.

In some other implementations, each TB in the set of TBs corresponds to a media access control (MAC) protocol data unit (PDU).

In some other implementations, the time unit comprises at least one of the following: a transmission time interval (TTI), a slot, a sub-frame, or a mini slot.

In some other implementations, the frequency unit comprises at least one of the following: a subcarrier, a resource block (RB), a subband, a bandwidth part (BWP), or a carrier.

In some other implementations, the same codeword comprises at least one of the following: a first codeword, or a second codeword.

In some other implementations, a mapping policy of the n TBs for a resource comprises at least one of the following: mapping, according to a mapping sequence number of each TB, the n TBs in a time domain, and then in a frequency domain;

mapping, according to the mapping sequence number of each TB, the n TBs in a frequency domain, and then in a time domain; or mapping, a TB corresponding to the second codeword according to the mapping sequence number of the TB corresponding to the first codeword in same time-frequency resource.

In some other implementations, the mapping sequence number of each TB in the n TBs comprises at least one of the following: an index of each TB; a sequence number based on a priority level of each TB; a sequence number generated randomly for each TB;

In some other implementations, the priority level of each TB in the n TBs comprises at least one of the following: a priority level based on a service demand from an upper layer; a priority level based on a quality of service (QOS) from the upper layer; or a priority level based on a transmission number of each TB.

In some other implementations, the first wireless device is configured to schedule transmission of the set of TBs, and the first wireless device comprises at least one of the following: a base station; a MAC layer in a wireless device; a scheduling unit; a user equipment (UE); an on-board unit (OBU); a road-side unit (RSU); or an integrated access and backhaul (IAB) node.

In some other implementations, the second wireless device is configured to receive transmission of the set of TBs, and the second wireless device comprises at least one of the following: a user equipment (UE); or an integrated access and backhaul (IAB) node.

In some other implementations, the first wireless device determines a transport block size (TBS) of each TB in the n TBs by: determining, based on a channel state information, a number of resource elements (REs), a modulation coding scheme (MCS), a number of layers; calculating a total size based on the number of REs, the MCS, and the number of layers; and determining the TBS of each TB in the n TBs based on the total size.

In some other implementations, the determining the TBS of each TB in the n TBs based on the total size comprises at least one of the following: determining the TBS of each TB as wherein ┌T/n┐ is the total size, n is the number of TBs in the n TBs, and ┌ ┐ is a ceiling function; determining the TBS of each TB as └T/n┘, wherein: └ ┘ is a floor function; determining the TBS of each TB based on a pre-determined value; or determining the TBS of each TB based on a pre-determined table.

In some other implementations, the sending, by the first wireless device to the second wireless device, control information corresponding to the resource allocation of the set of TBs, wherein the control information comprises at least one of the following: a resource space in a time-frequency domain for the set of TBs; a resource indication in a frequency domain for the set of TBs; a resource indication in a time domain for the set of TBs; an MCS for the n TBs; spatial multiplexing information related to a number of layers for the set of TBs; power control information for the set of TBs; an identification (ID) number for the set of TBs; a resource mapping configuration for the set of TBs; a number of TBs in the n TBs; a symbol position information in a time domain for each TB in the set of TBs; or a frequency position information in a frequency domain for each TB in the set of TBs.

In some other implementations, the second wireless device determines a transport block size (TBS) of each TB in the n TBs by: receiving the control information corresponding to the resource allocation of the set of TBs; determining, in a HARQ process, a number of resource elements (REs), a modulation coding scheme (MCS) for the n TBs, a number of layers; calculating a total size based on the number of REs, the MCS, and the number of layers; and determining the TBS of each TB in the set of TBs based on the total size.

In some other implementations, the control information is transmitted via at least one of the following: a downlink control information (DCI), a radio resource control (RRC) signaling, a high layer signaling, a MAC control element (CE), or system information.

In some other implementations, the determining the TBS of each TB in the n TBs based on the total size comprises at least one of the following: determining the TBS of each TB as T/n, wherein T is the total size and n is the number of TBs in the n TBs; determining the TBS of each TB as ┌T/n┐ wherein: ┌ ┐ is a ceiling function; determining the TBS of each TB as └T/n┘, wherein: └ ┘ is a floor function; determining the TBS of each TB based on a pre-determined value; or determining the TBS of each TB based on a pre-determined table.

In some other implementations, the HARQ process corresponds to data transmission for a HARQ in the time unit; and the time unit comprises at least one of the following: a transmission time interval (TTI), a slot, a sub-frame, or a mini slot.

In some other implementations, the method 600 may optionally further includes one or more of the following steps: receiving, by the second wireless device, the control information from the first wireless device; processing, by the second wireless device, the set of TBs based on the control information by at least one of the following: receiving data from the first wireless device based on the control information from the first wireless device; sending data to the first wireless device based on the control information from the first wireless device; sending data to a third wireless device based on the control information from the first wireless device; or receiving data from the third wireless device based on the control information from the first wireless device.

In some other implementations, the third wireless device is configured to receive or send transmission of the set of TBs, and the third wireless device comprises at least one of the following: a user equipment (UE); or an integrated access and backhaul (IAB) node.

In some other implementations, the method 600 may optionally further includes one or more of the following steps: in response to receiving the data from the first wireless device, sending, by the second wireless device, feedback information to the first wireless device by at least one of the following: sending the feedback information separately for each TB in the n TBs; sending the feedback information together for the n TBs; sending the feedback information for each code block (CB) in the n TBs; or sending the feedback information for each code block group (CBG) in the n TBs.

In some other implementations, the method 600 may optionally further includes one or more of the following steps: in response to receiving the data from the second wireless device, sending, by the third wireless device, feedback information to the first wireless device via the second wireless device by at least one of the following: sending the feedback information separately for each TB in the n TBs; sending the feedback information together for the n TBs; sending the feedback information for each code block (CB) in the n TBs; or sending the feedback information for each code block group (CBG) in the n TBs.

In some other implementations, the method 600 may optionally further includes one or more of the following steps: in response to the feedback information being same for each TB in the n TBs, sending the feedback information comprising a feedback indication for the n TBs, wherein: in response to each TB in the n TBs being received successfully, the feedback information comprises an acknowledgement (ACK) indication indicating each TB in the n TBs being received successfully; and in response to each TB in the n TBs being received unsuccessfully, the feedback information comprises a NAK indication indicating each TB in the n TBs being received unsuccessfully.

In one embodiment, referring to FIG. 7, a method 700 for wireless communication. The method 700 may include a portion or all of the following steps: step 710, receiving, by a second wireless device, a higher layer message carrying a radio configuration information of a set of TBs, wherein: the set of TBs comprises n TBs mapped to a same codeword, and n is an integer larger than 1, each TB mapped to the same codeword in the set of TBs is mapped to different time-frequency resource in a resource space comprising a time unit in a time domain and a frequency unit in a frequency domain, and each TB in the set of TBs is capable of being packaged separately at a transmitting end, and capable of being delivered separately to an upper layer at a receiving end; and/or step 720: in response to the higher layer message, operating, by the second wireless device, according to the radio configuration information of the set of TBs.

In some implementations, the higher layer message is at least one of the following: a layer 3 (L3) layer message, or a radio resource control (RRC) message.

In some other implementations, the radio configuration information comprises at least one of the following: a value of n, or a resource mapping policy.

In some other implementations, the resource space corresponds to the set of TBs in a hybrid automatic repeat request (HARQ) process in a carrier.

In some other implementations, each TB in the set of TBs corresponds to a media access control (MAC) protocol data unit (PDU).

In some other implementations, the time unit comprises at least one of the following: a transmission time interval (TTI), a slot, a sub-frame, or a mini slot.

In some other implementations, the frequency unit comprises at least one of the following: a subcarrier, a resource block (RB), a subband, a bandwidth part (BWP), or a carrier.

In some other implementations, the same codeword comprises at least one of the following: a first codeword, or a second codeword.

In some other implementations, a mapping policy of the n TBs for a resource comprises at least one of the following: mapping, according to a mapping sequence number of each TB, the n TBs in a time domain, and then in a frequency domain; mapping, according to the mapping sequence number of each TB, the n TBs in a frequency domain, and then in a time domain; or mapping, a TB corresponding to the second codeword according to the mapping sequence number of the TB corresponding to the first codeword in same time-frequency resource.

In some other implementations, the mapping sequence number of each TB in the n TBs comprises at least one of the following: an index of each TB; a sequence number based on a priority level of each TB; or a sequence number generated randomly for each TB;

In some other implementations, the priority level of each TB in the n TBs comprises at least one of the following: a priority level based on a service demand from an upper layer; a priority level based on a quality of service (QOS) from the upper layer; or a priority level based on a repeat transmission of each TB.

The present disclosure further describes various embodiments below, which serve as examples and should not be interpreted as any limitations to the present disclosure. In various embodiments, multiple TBs may refer to a set of TBs, wherein a number of TBs in the multiple TBs may be any be any positive integer.

### Embodiment 1: Common Scheduling Information for Multiple TBs

In a large bandwidth scenario, resources in a frequency domain may be abundant, and each user may be allocated enough bandwidth. A common (or same) scheduling method may be used to map, schedule, and/or transmit multiple TBs on a single carrier and using a single HARQ process at the same time on a TTI. The method may make full use of frequency domain resources, achieving high throughput and low latency requirements at the same time.

The method may include a portion or all of the following steps. The method may be performed by at least one of a first wireless device and/or a second wireless device. In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.
Step 1-1: For the second wireless device, for example a UE (UE1), that is successfully scheduled in single codeword transmission, the first wireless device, for example a base station (BS), may determine the multi-TB common scheduling information of UE1, such as available time-frequency domain resources, a modulation coding scheme (MCS), and/or a spatial multiplexing mode.
Step 1-2: According to the available time-frequency resources, the MCS, and a number of layers in the multi-TB common scheduling information of UE1, the base station may calculate a size of the largest TB that UE1 can transmit, where the largest TB is represented by TB_total, and the size of the largest TB may be expressed by TB_total size.
Step 1-3: The base station may evenly divide TB_total into n TBs according to TB_total size, and may calculate the size of each TB. When TB_total size is not completely divisible by n, some TBs use padding bits to ensure that the size of each TB in n TBs is the same. For example, when TB_total size is 20000 bits and n is 3, the size of the first and second TBs may be both 7000 bits, and the size of the third TB is 6000 bits plus 1000 bits of padding, which may be required to ensure that the sizes of 3 TBs are all 7000 bits.
Step 1-4: The base station may use the multi-TB common scheduling information corresponding to TB_total as the public (or common, or same) scheduling information of n TBs, and may perform physical layer processing on each TB and mapping on each TB of the n TBs to determine the dedicated scheduling information of each TB. Specifically, each TB may use a common modulation and coding method for modulation and coding; or each TB may use the same interleaving method for data interleaving; or each TB may use the same antenna transmission mode for antenna transmission; or for each TB, the same resource mapping policy may be used for mapping the data processed by the physical layer of each TB to specific time-domain symbols and frequency-domain resources in the common time-frequency domain.
Step 1-5: The base station may use a HARQ process to send the data of the n TBs on one TTI of a single carrier, and may send scheduling information of the n TBs to the UE via downlink control information (DCI). The scheduling information of n TBs includes at least one of the following, but not limited to: the range of time-frequency domain resources for transmitting the n TBs, the same MCS for n TBs, the same spatial multiplexing information for the n TBs, the same power control information for the n TBs, a group number for the n TBs, a mapping rule for the n TBs, a number of TBs n for the n TBs, a specific time domain symbol position of each TB for the n TBs, or a specific frequency domain resource position of each TB for the n TBs. The scheduling information of the base station for n TBs may be sent to UE1, wherein the scheduling information may include public scheduling information and dedicated scheduling information.

In various embodiments of this method, a single HARQ process may perform multiple TB scheduled transmissions on a scheduled transmission unit on a carrier. The total TB size may be larger than the maximum encoding block size of the encoder and the limit of the number of CBs and CBGs, achieving high throughput. Each TB may be decoded and feedback for each TB may be sent independently. Each successfully decoded TB may be independently delivered to a higher layer (for example, a MAC layer) without waiting for other TBs, further reducing the transmission delay and realizing the service requirements of large throughput and low latency with large bandwidth.

### Embodiment 2: Calculation of TB Size for Multiple TBs in a HARQ Process

The receiving side, for example a UE (UE1) in single codeword transmission, may receive transmissions of multiple TBs in a HARQ process. In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

Upon receiving scheduling information, the UE1 may perform, according to the indication of the scheduling information, reception processing on n TBs within a common time-frequency domain on a carrier. According to the scheduling information, the receiving side may infer the total size of n TBs and the size of each TB.

The method for determining a TB size (TBS) of TB may include a portion or all of the following steps.
Step 2-1: A UE may determine a number of total resource elements (REs) in a time-frequency domain in a HARQ process.
Step 2-2: The UE may calculate a number of total information bit (also referred as TB_total size) according to the number of total REs, an assigned MCS and a number of layers.
Step 2-3: The UE may determine a TB size of each TB in n TBs according to a TB size allocation rule. For one example, the TB size allocation rule may include a look-up table to obtain each TB size according to the value of n. For another example, the TB size allocation rule may include dividing TB_total size by n and upward rounding to the near integer to obtain the size of each TB.

### Embodiment 3: Transmission of Multiple TBs in a TTI

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

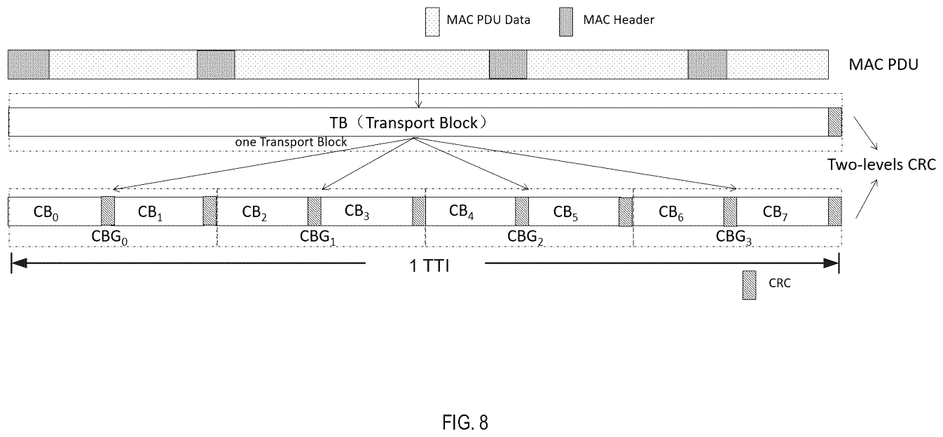

As shown in FIG. 8, in a 5G system, at a MAC layer, a MAC PDU may be composed of multiple sub-PDUs, and each sub-PDU is composed of a sub-header and a data part. MAC PDU is a data unit that may be delivered to a physical layer after the MAC layer protocol is processed. One MAC PDU may correspond to one TB of the physical layer. At the physical layer, a TB may be divided into one or more code block (CB) and/or one or more code block group (CBG). In a TTI and in a single HARQ process, when spatial multiplexing and multi-carrier are not considered, only one TB may be transmitted on a single carrier. In one TTI, only one TB is delivered to MAC layer.

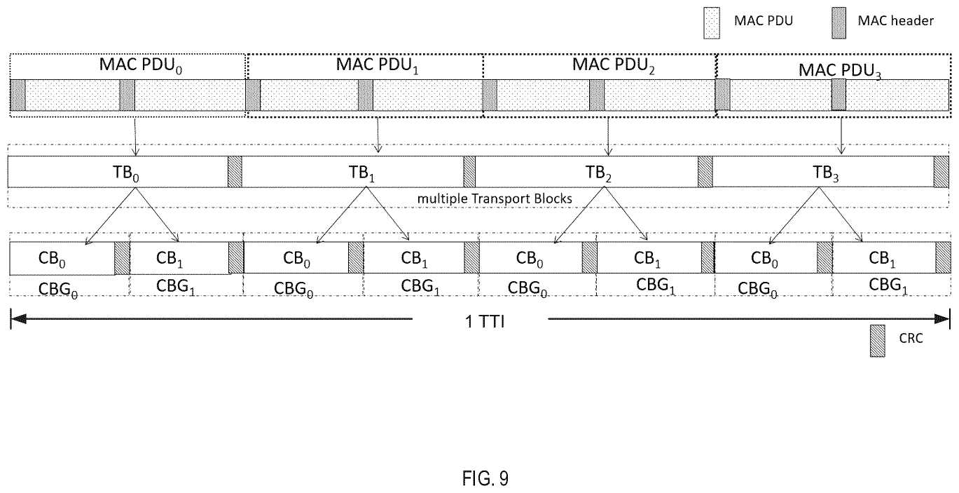

As shown in FIG. 9, in some implementations, one MAC PDU may still correspond to one TB of a physical layer. At the physical layer, each TB may still be divided into one or more CB and/or one or more CBG.

In a single HARQ process in a TTI, multiple MAC PDUs may be used to map to multiple TBs, and multiple TBs may be transmitted on a single carrier on a TTI. At the transmitting end, each TB corresponds to an independent MAC PDU, and each TB may independently be packaged at the transmitting end and be delivered to the MAC layer independently at the receiving end. At the receiving end, when receiving n TBs, there may be a situation where one or more TBs are transmitted correctly, and one or more TBs are transmitted incorrectly. In response to this situation, the data of correct TBs may be directly delivered to the MAC layer without waiting for the retransmission of the wrong (incorrectly transmitted) one or more TBs. In one TTI, one or more TBs may be delivered to MAC layer. This implementation may achieve lower latency while ensuring high throughput.

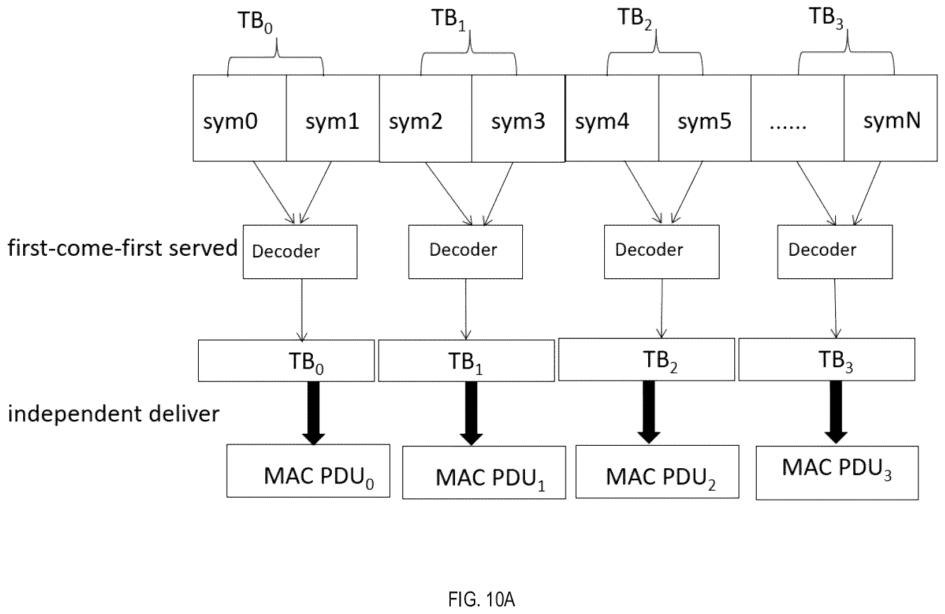

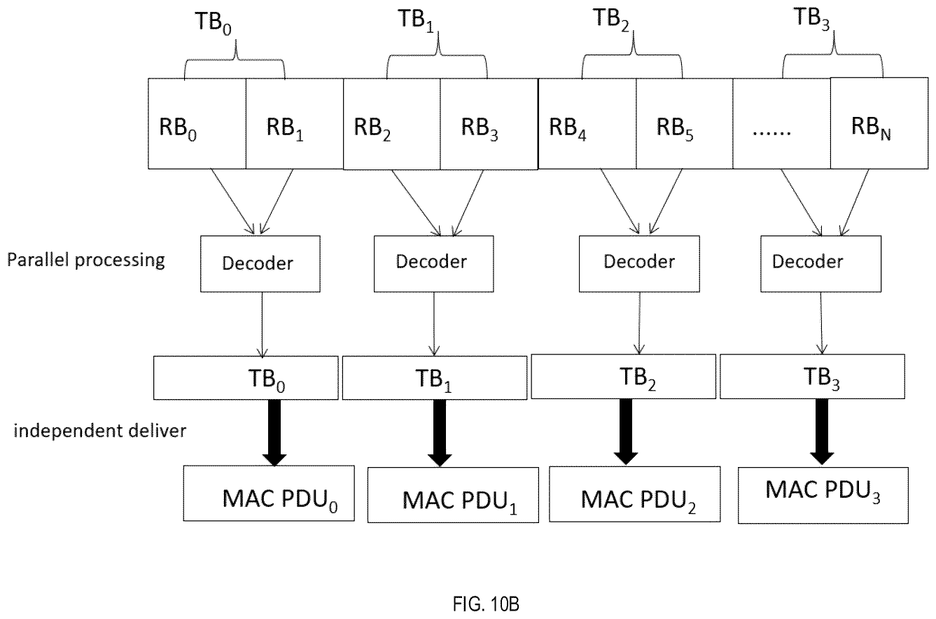

In some implementations, multiple MAC PDUs may be used to map to multiple TBs. As shown in FIG. 10A and FIG. 10B, the receiving end may include multiple decoders to decode each of the multiple TBs independently according to the scheduling instructions of multiple TBs. When multiple TBs in one TTI are mapped to different symbol of the time domain, the front (or earlier) TB with lower latency requirement then the behind (or later) TB. The performance of the system may be further improved by differential transmission latency. When multiple TBs in one TTI are mapped to different resource block (RB) of the frequency domain, the TBs of one TTI can be received simultaneously and parallel processing. The performance of the system may be further improved by decreasing the processing delay of decoding and achieving the effect of low latency.

### Embodiment 4: Configuration of n and Mapping Policy for Multiple TBs Via RRC Signaling

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

For multi-TB transmission in a TTI and in a single HARQ process on a single carrier, a network side, for example a base station, may send configuration information to a terminal via RRC signaling. The terminal may receive the RRC configuration message. The configuration information may include at least one of a value of n in same codeword transmission or mapping policy for a set of TBs.

For example, the network side may initiate the RRC reconfiguration process, and the RRC configuration information includes fields corresponding to transmission of multiple TBs. The fields in the configuration information may include the total number n of TBs in same codeword transmission in multiple TBs transmission and/or resource mapping policy for the multiple TBs. The UE may receive the RRC reconfiguration message. When the RRC reconfiguration message contains a transmission field for multiple TBs, the lower layer configuration of multi-TB is performed.

In some implementations, n is an integer greater than 1, and each TB of the n TBs may be independently packaged at the transmitting end, and may be independently delivered to the upper layer at the receiving end. TB resource mapping policy may correspond to a TB mapping strategy wherein each TB in multiple TBs may be mapped to a different time-frequency resource.

### Embodiment 5: Mapping Policy for Multiple TBs

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

After the base station determines the common scheduling information of n TBs, it may need to determine the time-frequency resource location for each TB of the n TBs in same codeword transmission. The time-frequency resource location of each TB may be determined according to one or more resource mapping policy.

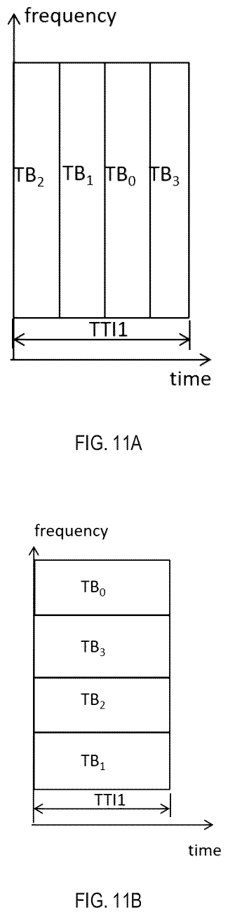

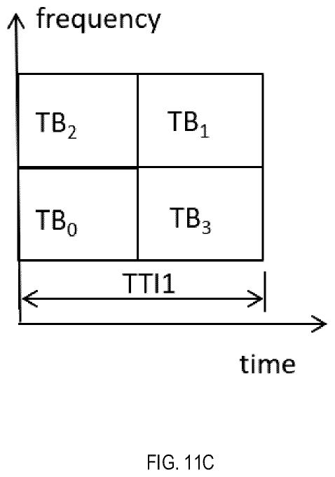

For example but not limited to, the one or more resource mapping policy may include one or a combinations of more than one policy. Referring to FIG. 11A, the mapping is performed according to the TB mapping sequence number; and the mapping is performed firstly in a time domain and then is performed in a frequency domain. Referring to FIG. 11B, the mapping is performed according to TB mapping sequence number; and the mapping is performed firstly in a frequency domain and then is performed in a time domain. Referring to FIG. 11C, the mapping is performed according to TB mapping sequence number; and the mapping is performed via a block-by-block manner in the time and frequency domain. In FIG. 11C, the mapping is performed firstly in a time domain and then is performed in a frequency domain. For example, TB₀ and TB₂ are mapped firstly in a time domain, TB₁ and TB₃ are mapped later in a time domain according to the mapping sequence numbers.

In some implementations, the TB mapping sequence number may include at least one of the following: an index number of the TB in the n TBs, a sequence number sorted by a TB priority, or a randomly generated TB mapping sequence number.

In some implementations, the TB priority may be at least one of an upper-layer service demand priority, an upper-layer quality of service (QOS) priority, or a TB retransmission priority. When a mapping rule is based on TB priority, the TB with higher priority may have high priority in being a first to select time-frequency domain resources for mapping.

### Embodiment 6: Joint Feedback for Multiple TBs

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

After receiving n TBs from a transmitting end, a receiving end, for example a UE, may send a feedback to the transmitting end to indicating the status of the received n TBs in same codeword transmission. The feedback may be a ACK/NACK of a single HARQ process. The feedback may be based on each TB, each CBG, each CB, and based on the joint feedback of n TBs. For n TB joint feedback, when all n TBs are decoded correctly, only 1-bit ACK joint feedback may be sent, indicating that all n TBs in same codeword transmission are successfully transmitted; when all n TBs in same codeword transmission are decoded unsuccessfully, only 1-bit NACK may be sent, indicating that the transmission of these n TBs has failed. Through joint feedback, the feedback overhead of multi-TB transmission is reduced.

### Embodiment 7: Uplink Scheduling and Transmission with Multiple TBs

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

In some implementations, a base station may perform uplink scheduling with multiple TBs, and a UE may transmit multiple TBs, achieving high-throughput and low-latency uplink transmission. Various implementations may include a portion or all of the following steps.
Step 7-1: The base station may perform joint scheduling on the n TBs in same codeword transmission for the UE, and may allocate, for the n TBs, a same MCS, a common time-frequency domain range, and one or more common mapping rule used by the n TBs on a carrier. A value of n may be determined according to business/service requirements, which may include bandwidth, throughput, latency, and/or delay.
Step 7-2: The base station may send the uplink scheduling information of n TBs in same codeword transmission to the UE. The uplink scheduling information may include at least one of the following: the same MCS, the common time-frequency domain range used by the n TBs, the common mapping policy, the time domain symbol position of each TB, the frequency domain position of each TB, and the antenna transmission mode of each TB.
Step 7-3: The UE may perform physical layer processing and mapping on each of the n TBs according to the uplink scheduling information.
Step 7-4: The base station may send feedback to the UE after receiving the n TB data transmitted by the UE. The feedback may include at least one of the following: a joint feedback based on n TBs, a feedback based on each TB, a feedback based on each CB, or a feedback based on each CBG.

### Embodiment 8: Two-Level Scheduling

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

Some implementations may include two-level scheduling in a single codeword transmission, which may include a portion or all of the following steps.
Step 8-1: A base station may determine a common scheduling information of a maximum TB (TB_total) of each UE, which includes at least one of the following:
allocating time-frequency domain resources, an MCS, a spatial multiplexing layer, and/or a mapping rule to each UE.
Step 8-2: The base station may equally divide the maximum TB (TB_total) into n TBs, and determines at least one of the following: a specific symbol position of each TB in the n TBs in the time domain, and/or a specific TB position in the frequency domain according to the mapping policy.

### Embodiment 9: Common and/or Dedicated Scheduling Information Via DCI

In the method, the nTBs in a TTI in a carrier in a HARQ process are mapped to the first codeword. Unless specifically stated, the description may be described with a single (or one) codeword transmission on a single carrier as examples. But a two codeword transmission may be applicable as well for at least some of the various embodiments.

In some implementations, a base station may transmit common (or public) scheduling information for the multiple TBs via DCI. In some other implementations, a base station may transmit common scheduling information for the multiple TBs and dedicated scheduling information for each TB via DCI.

By sending a DCI to the UE, the base station may realize the scheduling and transmission of multiple TBs simultaneously in a single HARQ process for a single UE. The DCI may include public scheduling information for the multiple TBs, or it may include public scheduling information for the multiple TBs and dedicated scheduling information for each TB.

Common (or public) scheduling information for the multiple TBs means that each of the multiple TBs in a single HARQ process uses the same scheduling information. Common (or public) scheduling information for the multiple TBs may include at least one of the following: an MCS, a time-frequency domain resource range, a mapping rule, a TB group number, a TB group included TB information, a power control parameter, an antenna transmission mode, and/or a number of TBs in the multiple TBs.

Optionally, the base station also sends dedicated scheduling information for each TB in the multiple TBs, including at least one of the following: a TB number, a specific symbol position of the TB in the time domain, and/or a specific position of the TB in the frequency domain.

### Embodiment 10: In Semi-Persistent Scheduling (SPS): Same Scheduling Information for a Period of Time

In a semi-persistent scheduling (SPS), a base station may use a same scheduling information to perform simultaneous scheduling and transmission of multiple TBs of a single HARQ process within a period of time, thereby reducing overhead to indicate the scheduling information.

In the SPS scheduling scenario, the base station may determine that a single carrier transmits multiple TB scheduling information for a single HARQ process on a TTI. For example, in a period of time, which may be relatively long, a number and a size of TBs in a single HARQ process may remain unchanged, an MCS may remain unchanged, and/or a TB time-frequency resource location may remain unchanged.

### Embodiment 11: Device-to-Device (D2D) Scenario

In a device-to-device (D2D) scenario, a base station may determine the scheduling information of a UE (for example, UE1). The UE1 may send multiple TB data to another UE (for example UE2) in one HARQ process according to the multi-TB scheduling information of a single HARQ process determined by the base station. The UE2 may send feedback to the base station after receiving the data. The embodiment may be applicable to other scenarios, for example but not limited to, integrated access and backhaul (IAB).

### Embodiment 12: Scheduling Transmission of Multiple TBs in a Two Codeword Transmission

For a 5G system, one TB corresponds one codeword. When a spatial multiplexing technology is used, a single carrier may be allowed to transmit two TBs of the user in one HARQ process in one TTI in the manner of two codeword transmission. In two codeword transmission, one TB is mapped to the first codeword, and another TB is mapped to the second codeword. The two TBs may use the same time-frequency resources. But each TB has its own MCS and layer number corresponding its codeword.

In various embodiments in the present disclosure, two TBs in one HARQ process in one TTI may be transmitted in scenarios of multi-TB transmission under dual codeword stream/transmission.

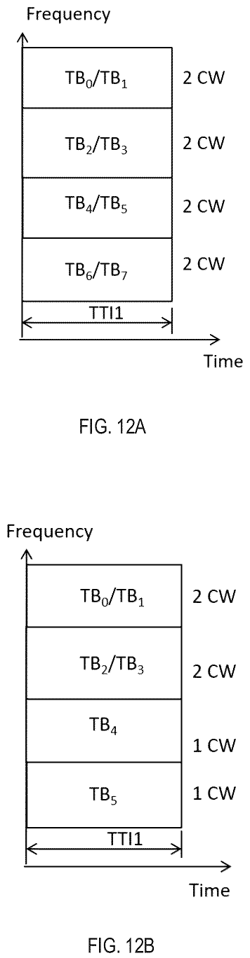

As shown in FIG. 12A, in a single carrier and in one HARQ process, a UE may achieve 8 TB transmission in a two codeword transmission within a TTI, while a 5G system in previous technology may only achieve 2 TB transmission under the same circumstances. In some other implementation, as shown in FIG. 12B, a UE may achieve some TB transmission (e.g., TB₀, TB₁, TB₂, TB₃) in a two codeword transmission and some TB transmission (e.g., TB₄, TB₅) in a one codeword transmission.

As shown in FIG. 12A, for example, TB₀ and TB₁ corresponding two codeword is in the same time-frequency resource. TB₀ corresponds the first codeword, and TB₁ corresponds the second codeword. There are 4 TBs (TB₀, TB₂, TB₄, TB₆) in the first codeword in one TTI, and 4 TBs (TB₁, TB₃, TB₅, TB₇) in the second codeword in one TTI. The 4 TBs of TB₀, TB₂, TB₄, and TB₆ use the same MCS and spatial multiplexing layer mapping (the same layer number). The 4 TBs of TB₁, TB₃, TB₅, and TB₇ use the same MCS and spatial multiplexing layer mapping (the same layer number).

The present disclosure describes methods, apparatus, and computer-readable medium for wireless communication. The present disclosure addressed the issues with transmitting multiple transport blocks (TBs). The methods, devices, and computer-readable medium described in the present disclosure may facilitate the performance of wireless communication by transmitting multiple transport blocks (TBs), thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting a set of transport blocks (TBs) between a first wireless device and a second wireless device by:
receiving, by the second wireless device, a resource indication from the first wireless device, wherein:
the resource indication indicates resource allocation of the set of TBs in a resource space comprising a time unit in a time domain and a frequency unit in a frequency domain;
each TB mapped to a same codeword in the set of TBs is mapped to different time-frequency resource in the resource space;
the set of TBs comprises n TBs mapped to the same codeword, and n is an integer larger than 1; and
each TB in the set of TBs is capable of being packaged separately at a transmitting end, and capable of being delivered separately to an upper layer at a receiving end.

2. The method according to claim 1, wherein:
the resource space corresponds to the set of TBs in a hybrid automatic repeat request (HARQ) process in a carrier.

3. The method according to claim 1, wherein:
each TB in the set of TBs corresponds to a media access control (MAC) protocol data unit (PDU).

4. The method according to claim 1, wherein:
the time unit comprises at least one of the following:
a transmission time interval (TTI),
a slot,
a sub-frame, or
a mini slot.

5. The method according to claim 1, wherein:
the frequency unit comprises at least one of the following:
a subcarrier,
a resource block (RB),
a subband,
a bandwidth part (BWP), or
a carrier.

6. The method according to claim 1, wherein the same codeword comprises at least one of the following: a first codeword, or a second codeword.

7. The method according to claim 1, wherein:
a mapping policy of the n TBs for a resource comprises at least one of the following:
mapping, according to a mapping sequence number of each TB, the n TBs in a time domain, and then in a frequency domain;
mapping, according to the mapping sequence number of each TB, the n TBs in a frequency domain, and then in a time domain; or
mapping, a TB corresponding to a second codeword according to the mapping sequence number of the TB corresponding to a first codeword in same time-frequency resource.

8. The method according to claim 7, wherein:
the mapping sequence number of each TB in the n TBs comprises at least one of the following:
an index of each TB;
a sequence number based on a priority level of each TB;
a sequence number generated randomly for each TB;

9. The method according to claim 8, wherein:
the priority level of each TB in the n TBs comprises at least one of the following:
a priority level based on a service demand from an upper layer;
a priority level based on a quality of service (QOS) from the upper layer; or
a priority level based on a repeat transmission number of each TB.

10. The method according to claim 1, wherein:
the first wireless device determines a transport block size (TBS) of each TB in the n TBs by:
determining, based on a channel state information, a number of resource elements (REs), a modulation coding scheme (MCS), a number of layers;
calculating a total size based on the number of REs, the MCS, and the number of layers; and
determining the TBS of each TB in the n TBs based on the total size.

11. The method according to claim 10, wherein the determining the TBS of each TB in the n TBs based on the total size comprises at least one of the following:
determining the TBS of each TB as ┌T/n┐, wherein T is the total size, n is the number of TBs in the n TBs, and ┌ ┐ is a ceiling function;
determining the TBS of each TB as └T/n┘ wherein: └ ┘ is a floor function;
determining the TBS of each TB based on a pre-determined value; or
determining the TBS of each TB based on a pre-determined table.

12. The method according to claim 1, wherein:
receiving, by the second wireless device from the first wireless device, control information corresponding to the resource allocation of the set of TBs, wherein the control information comprises at least one of the following:
a resource space in a time-frequency domain for the set of TBs;
a resource indication in a frequency domain for the set of TBs;
a resource indication in a time domain for the set of TBs;
an MCS for the n TBs;
spatial multiplexing information related to a number of layers for the set of TBs;
power control information for the set of TBs;
an identification (ID) number for the set of TBs;
a resource mapping configuration for the set of TBs;
a number of TBs in the n TBs;
a symbol position information in a time domain for each TB in the set of TBs; or
a frequency position information in a frequency domain for each TB in the set of TBs.

13. The method according to claim 12, wherein:
the second wireless device determines a transport block size (TBS) of each TB in the n TBs by:
receiving the control information corresponding to the resource allocation of the set of TBs;
determining, in a HARQ process, a number of resource elements (REs), a modulation coding scheme (MCS) for the n TBs, a number of layers;
calculating a total size based on the number of REs, the MCS, and the number of layers; and
determining the TBS of each TB in the set of TBs based on the total size.

14. The method according to claim 12, wherein:
the control information is transmitted via at least one of the following:
a downlink control information (DCI),
a radio resource control (RRC) signaling,
a high layer signaling,
a MAC control element (CE), or
system information.

15. The method according to claim 13, wherein the determining the TBS of each TB in the n TBs based on the total size comprises at least one of the following:
determining the TBS of each TB as T/n, wherein T is the total size and n is the number of TBs in the n TBs;
determining the TBS of each TB as ┌T/n┐ wherein: ┌ ┐ is a ceiling function;
determining the TBS of each TB as └T/n┘ wherein: └ ┘ is a floor function;
determining the TBS of each TB based on a pre-determined value; or
determining the TBS of each TB based on a pre-determined table.

16. The method according to claim 12, further comprising:
receiving, by the second wireless device, the control information from the first wireless device;
processing, by the second wireless device, the set of TBs based on the control information by at least one of the following:
receiving data from the first wireless device based on the control information from the first wireless device;
sending data to the first wireless device based on the control information from the first wireless device;
sending data to a third wireless device based on the control information from the first wireless device; or
receiving data from the third wireless device based on the control information from the first wireless device.

17. The method according to claim 16, further comprising:
in response to receiving the data from the first wireless device, sending, by the second wireless device, feedback information to the first wireless device by at least one of the following:
sending the feedback information separately for each TB in the n TBs;
sending the feedback information together for the n TBs;
sending the feedback information for each code block (CB) in the n TBs; or
sending the feedback information for each code block group (CBG) in the n TBs.

18. (canceled)

19. The method according to claim 17, further comprising:
in response to the feedback information being same for each TB in the n TBs, sending the feedback information comprising a feedback indication for the n TBs, wherein:
in response to each TB in the n TBs being received successfully, the feedback information comprises an acknowledgement (ACK) indication indicating each TB in the n TBs being received successfully; and
in response to each TB in the n TBs being received unsuccessfully, the feedback information comprises a NAK indication indicating each TB in n TBs being received unsuccessfully.

20. The method according to claim 1, wherein:
the first wireless device is configured to schedule transmission of the set of TBs, and the first wireless device comprises at least one of the following:
a base station;
a MAC layer in a wireless device;
a scheduling unit;
a user equipment (UE);
an on-board unit (OBU);
a road-side unit (RSU); or
an integrated access and backhaul (IAB) node.

21. The method according to claim 1, wherein:
the second wireless device is configured to receive transmission of the set of TBs, and the second wireless device comprises at least one of the following:
a user equipment (UE); or
an integrated access and backhaul (IAB) node.

22-35. (canceled)

36. A wireless communication apparatus comprising:
a memory storing instructions; and
a processor in communication with the memory, wherein, when the processor executes the instructions, the processor is configured to cause the wireless communication apparatus to perform:
transmitting a set of transport blocks (TBs) between a first wireless device and the wireless communication apparatus by:
receiving a resource indication from the first wireless device, wherein:
the resource indication indicates resource allocation of the set of TBs in a resource space comprising a time unit in a time domain and a frequency unit in a frequency domain;
each TB mapped to a same codeword in the set of TBs is mapped to different time-frequency resource in the resource space;
the set of TBs comprises n TBs mapped to the same codeword, and n is an integer larger than 1; and
each TB in the set of TBs is capable of being packaged separately at a transmitting end, and capable of being delivered separately to an upper layer at a receiving end.

37. A non-transitory computer program product comprising a computer-readable program medium storing instructions, wherein, the instructions, when executed by a processor, are configured to cause the processor to perform:
transmitting a set of transport blocks (TBs) between a first wireless device and a second wireless device comprising the processor by:
receiving a resource indication from the first wireless device, wherein:
the resource indication indicates resource allocation of the set of TBs in a resource space comprising a time unit in a time domain and a frequency unit in a frequency domain;
each TB mapped to a same codeword in the set of TBs is mapped to different time-frequency resource in the resource space;
the set of TBs comprises n TBs mapped to the same codeword, and n is an integer larger than 1; and
each TB in the set of TBs is capable of being packaged separately at a transmitting end, and capable of being delivered separately to an upper layer at a receiving end.
